(19) United States
(12) Patent Application Publication
(10) Pub. No.: US 2004/0125426 A1
(43) Pub. Date: Jul. 1, 2004

(54) Optical logic gates using semiconductor optical amplifiers

(76) Inventor: Alastair D. McAulay, Allentown, PA (US)

Correspondence Address: Eastman & Associates, Suite 1800, 707 Broadway Street, San Diego, CA, 92101, US

(21) Appl. No.: 10/613,537

(22) Filed: Jul. 3, 2003

Related U.S. Application Data
(60) Provisional application No. 60/393,928, filed on Jul. 3, 2002.

(51) Int. Cl. G02F 3/00

(52) U.S. Cl. 359/108

(57) ABSTRACT

All-Optical logic can avoid expensive demultiplexing back to electronics in telecommunications. The term all-optical is used to described processing in which all signal paths are optical whether used for control or information. Semiconductor optical amplifiers (SOAs) can perform all optical logic because they have nonlinearity, low latency, and require low power. We use highly accurate computer models to simulate and evaluate NOR and NXOR logic gates using SOAs. These elements can act as building blocks for advanced logic systems. For example, in previous publications we described an approach to constructing arithmetic units form optical logic elements.

### CROSS REFERENCE TO RELATED APPLICATIONS

This application claims the benefit of priority from Provisional Patent Application Serial No. 60/393,928 filed Jul. 3, 2002 entitled “All Optical Logic Gates Using Semiconductor Optical Amplifiers”, currently co-pending.

It is expensive in telecom system to switch back from high speed optics to electronics because of the need to demultiplex hundreds of channels to rates that the electronics can handle and then multiplex them back into optics after processing. Further, the expensive electronics must be replaced for each new generation of faster telecom equipment. Therefore, processing by all-optical logic [5] is a long term goal for the telecom industry. The logic must operate at over 2.5 Gbps. All optical logic has the important advantage that the links can become transparent to bit rate, protocol, frequency etc. This allows cost effective expansion to the next faster generation of telecom equipment.

Previously we proposed an all optical design for a bit serial ripple carry adder consisting of full adders and using semiconductor optical amplifiers in cross gain modulation as all-optical logic elements [4]. The bits were assigned different frequencies to allow parallel computation and to take advantage of the wavelength division multiplexing technology developed for the telecom industry. The term all-optical is used to described processing in which all signal paths are optical whether used for control or information. Semiconductor optical amplifiers (SOAs) can perform all optical logic because they have nonlinearity, low latency, and require low power.

In this paper we investigate more closely the performance of SOAs as all-optical logic NOR (not OR) and NXOR (not exclusive OR) gates using more exact device models and operating at 2.5 Gbps with return to zero (RZ) signals. The truth table for OR, NOR, XOR and NXPR gates is describe in Table 1.

In section 2, we show simulation results characterizing SOAs and describe briefly the principle of cross-gain modulation (XGM). In section 3 we show simulation results for all-optical NOR gates. Results for simulating all-optical NXOR gates are shown in section 4.

2. Semiconductor Optical Amplifier Characteristics

Characteristics for an SOA depend on the type of SOA, for example, a multiple quantum well device (MQW) has different properties from a bulk device.

2.1 Characteristics of SOAs

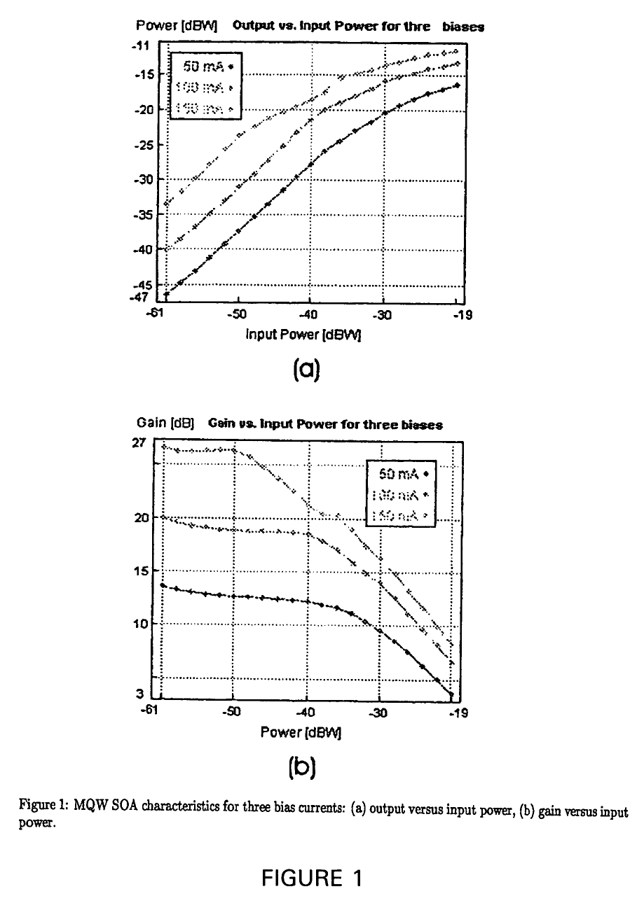

Semiconductor optical amplifiers (SOAs) are similar to laser diodes but have minimal reflective facets so that most of the light passes only once through the SOA. FIG. 1(a) shows the input-output characteristics of the multiple quantum well (MQW) device semiconductor optical amplifiers (SOAs) used for three different bias currents, 50 mA, 100 mA and 150 mA. A light wavelength 1550 nm or a corresponding light frequency 193.1 THz (10¹² Hz) was used. As the device saturates, the output no longer increases at the same rate due to gain saturation. The output saturation power at which the gain has fallen by 3 dB from the peak (i,e the half power point) is an important parameter of the SOA. Gain saturation is shown as a function of input power in FIG. 1(b).

2.2 Principle of Cross Gain Modulation

Cross-gain modulation (XGM) is semiconductor optical amplifiers has been investigated extensively for wavelength shifting,[3],[1],[9] and has been used for NOR gates [6] and digital information processing [4]. Wavelength converters have been operated at 20 Gbps [8] and signal and probe levels for optimum performance have been studied [2], [7]. The principle relies on the fact that the gain of a semiconductor optical amplifier falls off with increasing input power, FIG. 1(b). This permits cross coupling between inputs that have different frequencies. A modulated pump signal at the XGM-SOA input causes it to go in and out of saturation according to the bit status ‘1’ or ‘0’. A continuous wave probe at a different wavelength from the pump is also supplied to the XGM-SOA in a co-propagating or counter-propagating connection. The probe is modulated by the gain. The signal has been transferred from the pump wavelength at the input to the XGM-SOA to the probe wavelength at the XGM-SOA output. This is known as frequency shifting or frequency conversion. The performance depends on the wavelengths, signal levels and bit rates. Note that the output modulation is the inverse or complement of the input modulation for a single XGM stage. For this reason a single stage performs a NOT logic operation while moving the signal from one frequency to another. In fact by connecting two signals into the input, an SOA in XGM can perform a NOR operation in a manner similar to a transistor. Next we show simulation results for NOR and NXOR logic gates.

3. NOR Gate Using SOAS in Cross-gain Modulation

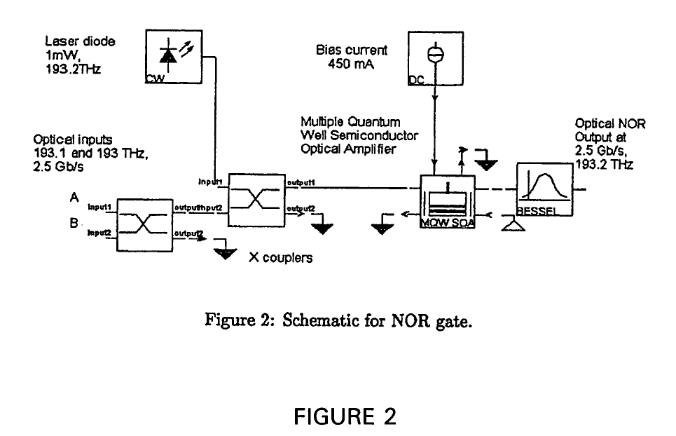

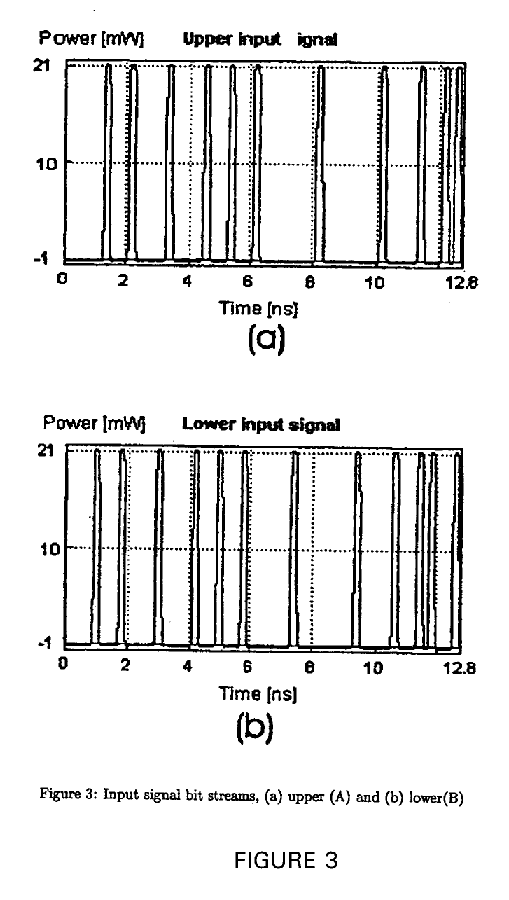

FIG. 2 shows a schematic for a NOR gate using an SOA in cross gain modulation. The NOR gate inputs are two 2.5 Gbps RZ bit streams. The signals at inputs A and B have frequencies of 193.1 THz and 193 THz respectively. Sample bit streams from a random number generator are shown for the upper (A) and lower (B) inputs in FIGS. 3(a) and 3(b) respectively. The probe laser provides continuous wave (CW) light at 193.2 THz. This passes through the SOA and is modulated by the changing gain. The output is the inverse of the OR operation or a NOR of the two inputs at A and B. Note that, regardless of whether the inputs are noisy, wideband or have unknown frequencies, the output has been placed on a clean new frequency at 193.2 THz. The SOA must saturate when a one appears at either input so that when a one level appears at both inputs simultaneously, there is no change in output, as required for cascadable all-optical logic gates. A band pass filter at the output passes only the 193.2 frequency. This filter is required when using co-propagation of input signals and probe.

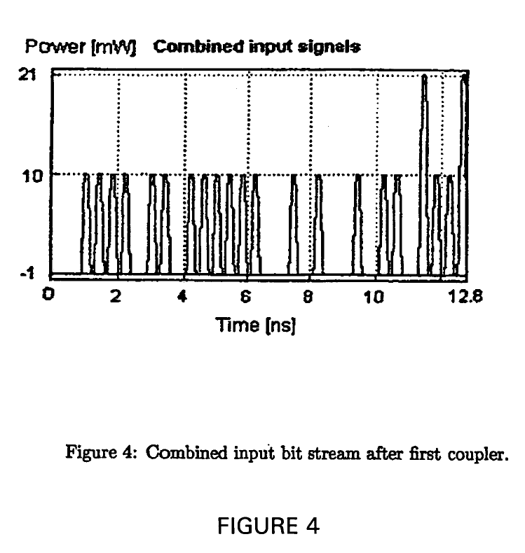

The combined inputs A +B at the output of the first x-coupler in FIG. 2 is shown in FIG. 4 and this signal will cause gain compression due to device saturation in the SOA. Comparisons with FIGS. 3(a) and (b) shows that there is an output when either input is a ‘one’ level and when bother outputs are a ‘one’ level. However, the addition operation causes the output for ‘one’ at both inputs to be twice the intensity as that when only one input is ‘one’.

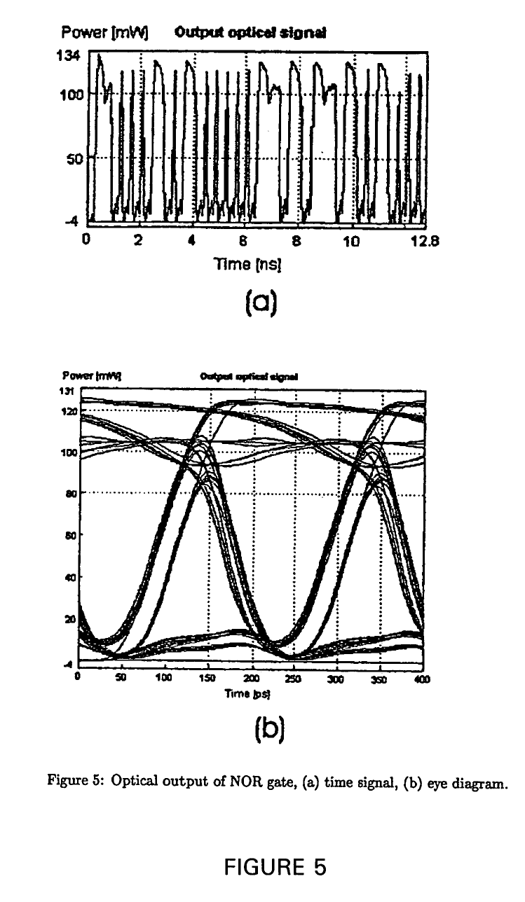

The optical output for the NOR gate is shown in FIG. 5(a). Note that the output is the inverse of the OR operation seen at the combined signal out of the first x-coupler, FIG. 4, that is it goes low when the combined signal, FIG. 4, goes high and vise versa. Also, when both inputs are present in FIG. 4, FIG. 5(a) shows a decrease in the peak intensity of the spike immediately following. This represents undesired data dependent behavior and increases the bit error rate of the data. The overlayed figure of ones and zeros is shown in the eye diagram, FIG. 5(b). Note that a clear region vertically in the center of the eye ensures that the ‘one’ and ‘zero’ levels can be distinguished from each other in the receiver. The horizontal space in the center of the eye ensures that a bit is not confused with its neighbor in the receiver, which would result in intersymbol interference.

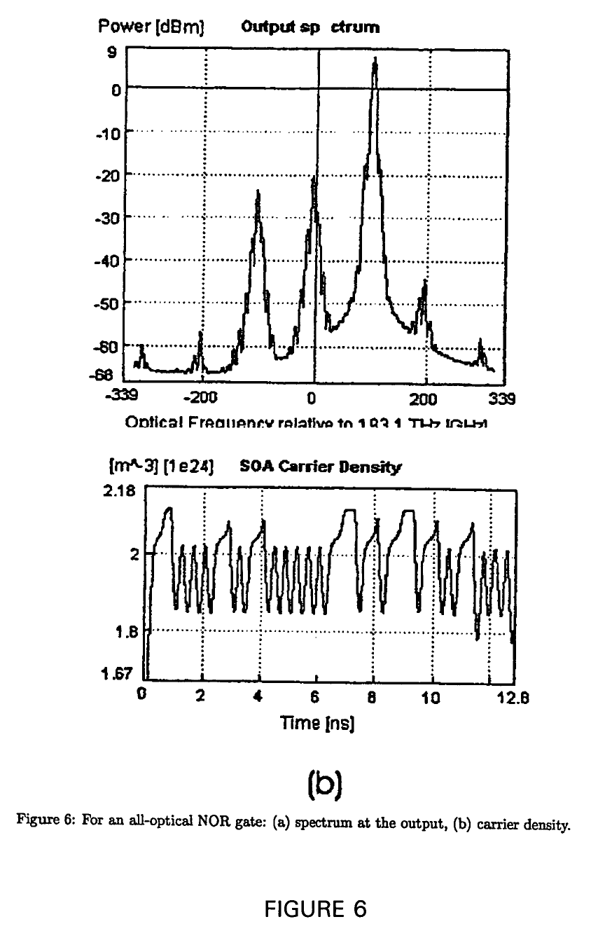

FIG. 6(a) shows the output spectrum, the two input frequencies, reduced in intensity by the filter, and the output frequency are seen.

When an optical pulse passes through an SOA, carriers are withdrawn from the conduction band to be converted into photons for amplification. The carrier reservoir is stocked by electrons from the continuous wave bias current. The data dependent behavior mentioned earlier, occurring when both signals have ones simultaneously, shows up in the carrier density for the SOA shown in FIG. 6(b). For a ‘one’ level occurring on the both inputs, it can be seen that the carriers are drawn down more than for a ‘one’ at only one of the inputs.

4. NXOR Gate Using SOAS in Cross-gain Modulation

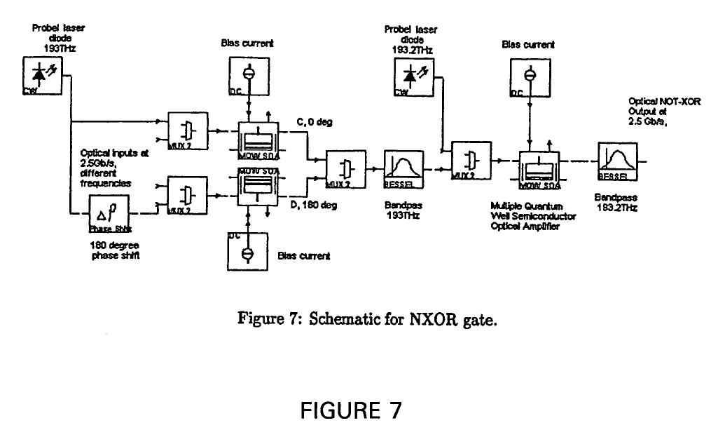

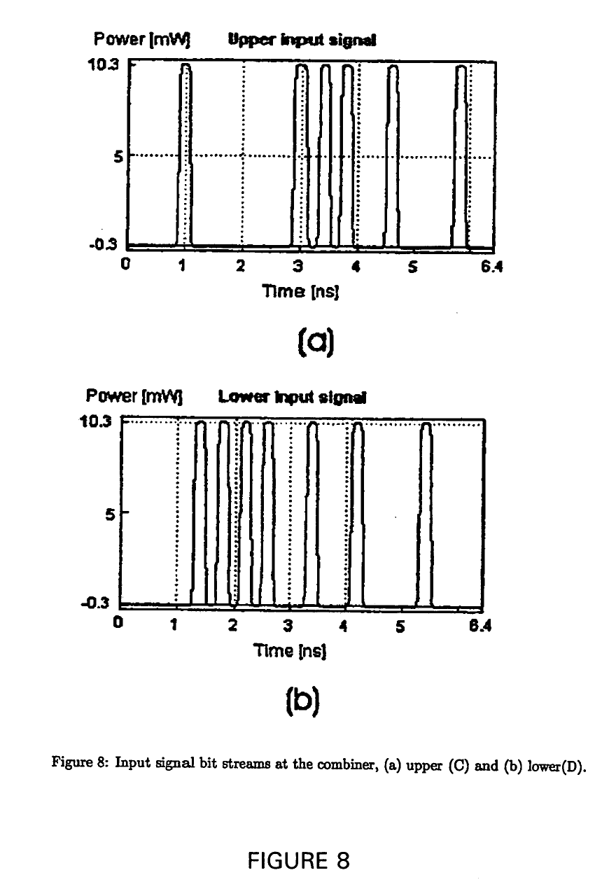

FIG. 7 shows a schematic for the NXOR (not exclusive OR) gate using an SOA in cross gain modulation. The difference between the NOR and NXOR gates is that in the latter, the output when both signals are present is the same as when neither signal is present, (see earlier truth table). This is accomplished by destructive interference (phase cancellation) between the two signals when bother signals have a ‘one’ level. For destructive interference to occur, the signals must have the exact same frequency and 180 degree phase difference. This is accomplished by shifting both input signals onto the same light frequency at 193 THz with a common 193 THz probe laser, FIG. 7. A phase shifter provides a 180 degree phase difference between inputs to allow phase cancellation of simultaneous ‘one’ levels on both inputs. The inputs at C and D in FIG. 7 are shown in FIGS. 8(a) and (b) respectively.

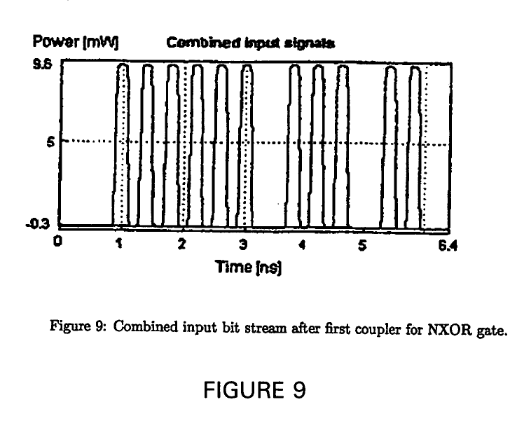

The combined input entering the leftmost bandpass filter in FIG. 7 is shown in FIG. 9. Note that both inputs have a one pulse midway between 3 and 4 ns and that these cancel each other by destructive interference to give zero in the combined signal. The operation performed is an exclusive OR, XOR.

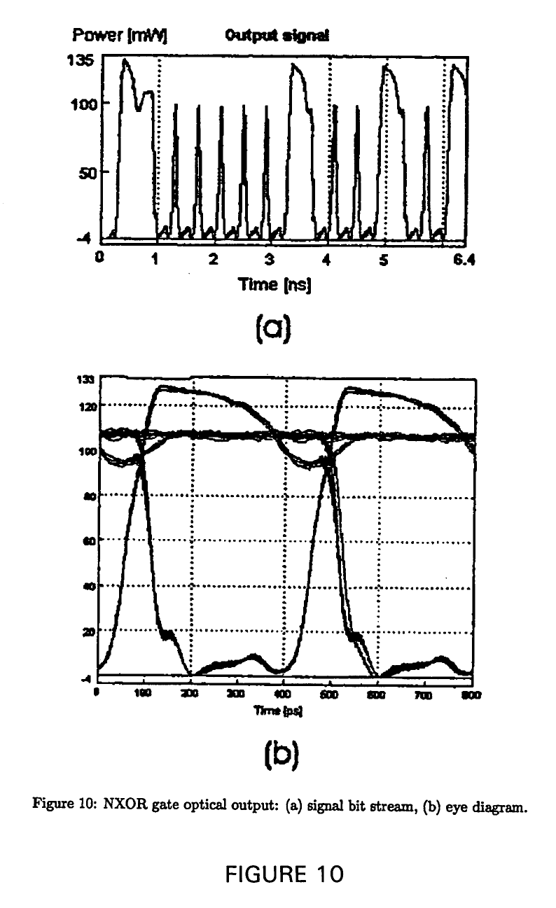

The XOR signal enters the third SOA operating in cross-gain mode with a probe laser at 193.2 THz. The SOA performs the inversion or NOT operation. The resulting optical output for the NXOR gate is shown in FIG. 10(a). Note that the output is the inverse of the XOR operation seen at the combined signal, FIG. 9, that is it goes low when the combined signal, FIG. 9, goes high and vice versa. The overlayed figure of ones and zeros is shown in the corresponding eye diagram, FIG. 10(b). Note that, as for the NOR gate, a clear region in the center of the eye ensures that in the receiver, the one and zero levels can be distinguished from each other and that a bit is not confused with its neighbors.

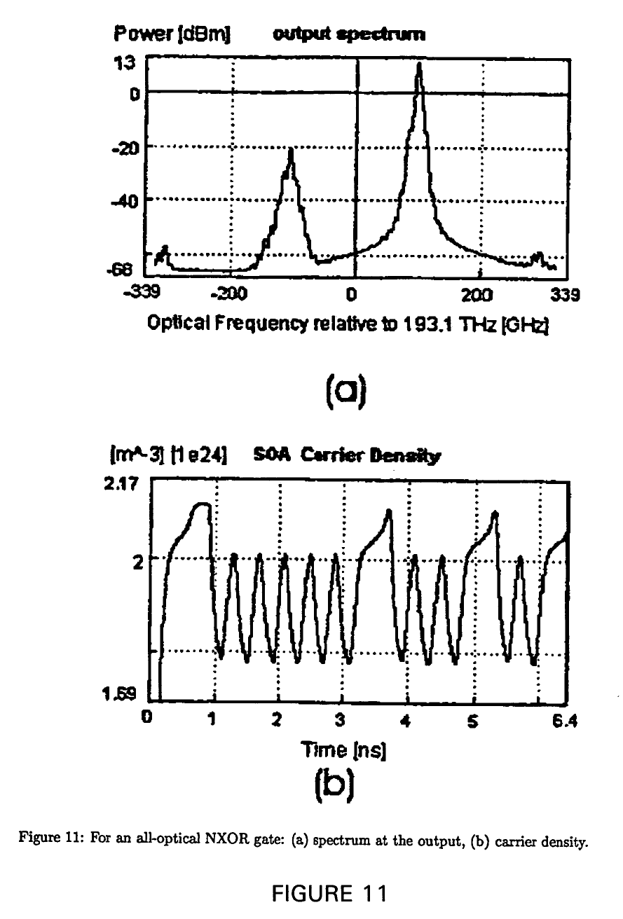

FIG. 11(a) shows the output spectrum after the SOA and band pass filter at 193.2 THz. The 193 THz common input frequency is suppressed in favor of the probe 193.2 THz onto which the signal has been transferred. FIG. 11(b) shows the carrier density for the SOA. Unlike the case of the NOR gate there is little sign of data dependent behavior.

### CONCLUSION

We showed with computer simulation that a semiconductor optical amplifier (SOA) can be used in cross gain modulation as an all-optical NOR gate with return to zero (RZ) input bit streams at 2.5 Gbps. All-optical meaning that the control is optical as well as the data path. A second SOA could be used to invert the signal to produce an all-optical OR gate. We also showed that a multiplexer can perform an all-optical logic XOR. This functions by using destructive phase interference when both input signals have a one level simultaneously. An SOA following the multiplexer performs a NOT operation to give an all-optical not-exclusive-OR or NXOR gate. However, in this case both signals must come from the same laser or be synchronized with each other in frequency and phase. The optical phase difference between inputs is set to 180 degrees. Frequenctly, in logic, the inputs come form difference laser sources. In this case two SOAs are used to convert the signal modulation from the input frequencies to the same laser source by using a common probe laser. The proposed all-optical logic gates can be used to construct more complex logic systems and can be made to operate at higher bit rates.

### REFERENCES

1. Durhuus, T., Mikkelsen, B., Joergensen, C., Daniealsen, S. L., and Stubjkear, K. E. All optical wavelength conversion by semiconductor optical amplifiers IEEE J. Lightwave Technol., 14 (1993) 942-954.

2. Glance, B., Wiesenfeld, J. M., Oren, U., Gnauck, A. H., Presby H. M., and Jourdon A., High performance optical wavelength shifter Electronics letters, 28 (1992) 1714-1715.

3. Lee, H. J., Sohn, M., Kim, K., and Kim, H. G. Wavelength dependent performance of a wavelength converter based on cross-gain modulation and birefringence of a semiconductor optical amplifier IEEE Photonics Technology Letters, 11 (2) (1999) 185-187.

4. A. D. McAulay, “Optical arithmetic unit using bit-WDM”, Optics and Laser Technology”, 32, 2000, pp. 412-427.

5. A. D. McAulay, Optical Computer Architectures. Wiley (1991).

6. Sharaiha, A., Li, H. W., Marchese, F., and Le Bihan, J. All-optical logic NOR gate using a semiconductor laser amplifier Electronics Letters, 33(4) (1997) 323-325.

7. Shieh, W., and Willner A. E., Optimal Conditions for high-speed all-optical SOA-based wavelength shifting IEEE Photonics Technology Letters, 7 (1995) 1273-1275.

8. Wiesenfeld, J. W., Perion, J. S., Gnauck, A. S., and Glance B., Bit error rate performance for wavelength conversion at 20 Gb/s. Electronics Letters, 30 (1994) 720-721.

9. Willner, A. E. and Shieh, W. Optimal spectral power parameters for all-optical wavelength shifting: single stage, fanout, and cascadability Journal of Lightwave Technology, 13(95) (1995) 771-781.

1. An optical logic gate, comprising:
a laser light source having an optical output having a first wavelength;
a first coupler having a first optical input receiving a first optical signal and a second optical input receiving a second optical signal; and generating an output comprising a portion of said first optical signal and said second optical signal;
a second coupler having a first optical input receiving a said output of said laser light source and a second optical input receiving said output from said first coupler and generating a third optical signal; and
a multiple quantum well semiconductor optical amplifier receiving said third optical signal and generating an optical signal that is the logical NOR of said first optical input and said second optical input.
